(19) United States
(12) Patent Application Publication
(10) Pub. No.: US 2007/0134141 A1
(43) Pub. Date: Jun. 14, 2007

(54) Apparatus for treating flue gas using single-stage gas dispersing tray

(76) Inventors: Seung Soo Park, Daejeon (KR); Ki Hyoung Kim, Daejeon (KR); Hi Soo An, Daejeon (KR); Kwang Kyu Park, Daejeon (KR); Hee Moon Uhm, Daejeon (KR)

Correspondence Address: CANTOR COLBURN, LLP, 55 GRIFFIN ROAD SOUTH, BLOOMFIELD, CT, 06002, US

(21) Appl. No.: 11/385,383

(22) Filed: Mar. 21, 2006

(30) Foreign Application Priority Data
Dec. 13, 2005 (KR) 10-2005-0122516

(51) Int. Cl. B01J 8/08

(52) U.S. Cl. 422/219

(57) ABSTRACT

An apparatus for treating flue gas using a single-stage gas dispersing tray, which removes sulfur dioxide from the flue gas exhausted from a thermal power plant. Oxidation air is injected into the lower portion of an absorption slurry riser so as to decrease the density of a gas-liquid (slurry) mixture rising through the absorption slurry riser, and a difference of densities of absorption slurry between the inside and the outside of an overflow weir serve as a driving force for circulating the absorption slurry positioned on and under the gas dispersing tray so as to maximize the amount of the circulating absorption slurry. Thereby, the apparatus has a high SO₂ removal efficiency even at a low operating pH and a low absorber pressure drop.

### BACKGROUND OF THE INVENTION

1. Field of the Invention

The present invention relates to an apparatus for treating flue gas using a single-stage gas dispersing tray, and more particularly to an apparatus for treating flue gas using a single-stage gas dispersing tray, which performs a wet flue gas desulfurization process for removing acid gas, particularly sulfur dioxide, from the flue gas exhausted from a thermal power plant burning fossil fuel.

2. Description of the Related Art

Generally, flue gas exhausted from a thermal power plant using fossil fuel, such as coal and oil, contains various contaminants. Particularly, sulfur dioxide is typical contaminant causing acid rain. Accordingly, a flue gas desulfurization process for removing sulfur dioxide from the flue gas is now widely used. Various methods of the flue gas desulfurization process have been developed and are in practical use. The flue gas desulfurization process is mainly performed by a wet limestone-gypsum method, which uses limestone as an absorbent and produces gypsum, and employs a forced oxidation method, which injects air for oxidation directly into an absorber.

The flue gas desulfurization process comprises several steps. A step of removing sulfur dioxide from the flue gas by gas-liquid contact is performed in the absorber. Accordingly, various attempts to increase an efficiency of gas-liquid contact in the absorber for reducing initial investment costs and increasing an efficiency of removing sulfur dioxide have been proposed. Absorber, which are installed in Korea now, are divided into a spray tower, which is mainly used, a grid packed tower, a jet bubbling reactor, and a gas layer perforated plate-type reactor.

The mass transfer using the gas-liquid contact is performed by a liquid spray method, in which a liquid is sprayed into a gas flow, and a gas dispersing method, in which a gas is dispersed directly into liquid. The spray tower employs the liquid spray method. Specifically, flue gas is blown into a middle portion of the spray tower and absorption slurry containing an absorbent positioned at the lower portion of the spray tower is transferred and sprayed towards the upper portion of the spray tower using absorber slurry recirculation pumps. In order to increase an efficiency of removing sulfur dioxide from the spray tower, a gas-liquid contact area and/or gas-liquid contact time must be increased.

However, when an L/G ratio (the amount of the sprayed slurry to the unit amount of the flue gas) is increased in order to increase the gas-liquid contact area, the power consumption of slurry pumps is increased. Further, when the diameter and the height of the spray tower are increased in order to increase the gas-liquid contact area and contact time, initial investment costs are increased.

Since the spray tower has a relatively simple internal structure, a pressure drop in the spray tower is relatively small. Further, since the spray tower has large-capacity slurry pumps serving to transfer the slurry to a position of a high height, the ratio of the power consumption of the slurry pumps to the total power consumption is high. Since the spray tower uses a limited number of large-capacity slurry pumps (generally, three pumps are operated and one pump is provided for standby), the flexibility of the spray tower according to the variation of the flue gas flow rate and the variation of sulfur dioxide concentration in the flue gas during operating the spray tower is low. That is, it is difficult to precisely control the concentration of sulfur dioxide (SO₂) at an outlet of the spray tower to a degree desired by an operator.

In order to solve the above drawback, a gas-dispersing type absorber, in which flue gas is directly dispersed into absorption slurry so that gas-liquid contact is induced, is developed. The gas-dispersing type absorber has an advantage to easily control absorber pressure drop during operating the absorber so that SO₂ removal efficiency is easily controlled with the variation of the flue gas flow rate and the variation of sulfur dioxide concentration in the flue gas. The gas-dispersing type absorber does not require slurry recirculation pumps, but requires a booster fan having relatively high discharge pressure to overcome the pressure drop in the absorber, thereby having a high ratio of the power consumption of the booster fan to the total power consumption amount. As apparatus using the above gas-dispersing type absorber, there are proposed gas layer perforated plate-type flue gas desulfurization apparatus (disclosed by Korean Patent No. 130410 and U.S. Pat. No. 5,660,616) and a jet bubbling reactor (disclosed by U.S. Pat. No. 4,368,060).

A complicated chemical reaction performed in the absorber can be briefly expressed with the following equations.
SO₂(g)+H₂O [symbol] H₂SO₃(aq) (1)
H₂SO₃(aq) [symbol] H⁺HSO₃⁻ (2)
O₂(g)+H₂O→O₂(aq) (3)
HSO₃⁻+½O₂(aq)→H⁺+SO₄²⁻ (4)
2H⁺+SO₄²⁻+CaCO₃+H₂O→CaSO₄.2H₂O+CO₂↑ (5)
CaSO₄.2H₂O(small)→CaSO₄.2H₂O(large) (6)

The equations (1) and (2) represent a reaction in which SO₂(g) in the flue gas is absorbed into an absorption slurry, and the reaction is a reversible, the reaction rate of which is determined by the composition of the absorption slurry. In order to cause the absorption slurry not to have a partial pressure of SO₂, an oxidation reaction represented by the equation (4) is important. The oxidation reaction is influenced by various factors, such as SO₂(g) concentration of inlet flue gas, the degree of natural oxidation due to oxygen contained in the flue gas, and the gas-liquid contact time. Generally, oxidation air as much twice to four times as the theoretical equivalent is injected into the absorber to oxidize SO₂ absorbed into the slurry.

The efficiency of gas-liquid contact in the gas-dispersing type absorber is varied according to the characteristics of a gas dispersion device, and a key point for determining the performance of the absorber is to obtain the maximum efficiency of gas-liquid contact with the minimum pressure drop of the absorber. The gas-dispersing type absorber comprises a bubbling layer positioned at the upper portion thereof, in which the gas-liquid contact is performed, and a reaction layer positioned at the lower portion thereof. In the bubbling layer, the reaction represented by the equations (1) and (2), in which SO₂(g) contained in flue gas is absorbed into an absorption slurry, and the reaction represented by the equation (4) are mainly performed, and in the reaction layer, the reaction represented by the equation (3), in which oxygen gas is dissolved into the slurry, and the reaction represented by the equation (6), in which generated gypsum is crystallized, are mainly performed.

In a conventional gas layer perforated plate-type flue gas desulfurization apparatus and method (disclosed by Korean Patent No. 130410) and a conventional gas-liquid contact device for treating flue gas (disclosed by Korean Patent No. 219728), a single-stage gas dispersing tray through which a number of gas holes are bored is used as the gas-liquid contact device. A gas layer is formed under the gas dispersing tray by the pressure of the flue gas introduced under the gas dispersion tray, and a bubbling layer is formed on the gas dispersion tray by ejecting the flue gas through the gas holes. When a gas-liquid(slurry) mixture on the gas dispersing tray having a high potential energy due to the formation of the bubbling layer overflows an overflow weir having an appropriate height and flows to the lower part, a difference of hydraulic heads of the absorption slurry between the inside and the outside of the overflow weir is generated. The difference of hydraulic heads serves as a driving force for continuously circulating the absorption slurry positioned under and on the gas dispersing tray, thereby allowing the absorption slurry positioned under and on the gas dispersing tray to be circulated through a slurry downcomer and slurry risers without any separate circulation pump.

In this device, since the absorption slurry positioned on the gas dispersing tray directly absorbs SO₂(g), overflows the overflow weir, and flows to the lower part of the absorber under the gas dispersing tray through the slurry downcomer, and slurry, which restores its SO₂-absorbing capacity due to oxidation air and limestone serving as an absorbent supplied from the lower part of the absorber, is supplied to the upper part of the absorber on the gas dispersion tray through the slurry risers, it is possible to continuously remove SO₂. Accordingly, the amount of the circulating slurry between on and under the gas dispersing tray highly influences a SO₂ removal efficiency. However, in this method, since the circulation of the absorption slurry positioned on and under the gas dispersing tray is performed by the difference of hydraulic heads of the absorption slurry between the inside and the outside of the overflow weir, the amount of circulating slurry is limited.

### SUMMARY OF THE INVENTION

Therefore, the present invention has been made in view of the above problems, and it is an object of the present invention to provide an apparatus for treating flue gas using a single stage gas dispersing tray, in which the amount of the circulating slurry between on and under the gas dispersion tray is increased, thereby increasing a SO₂ removal rate even at a low operating pH and a low absorber pressure drop.

In order to accomplish the above and other objects, oxidation air is supplied to the lower part of the absorption slurry riser of an apparatus, thereby decreasing density of a gas-liquid (slurry) mixture rising through the absorption slurry riser acts as a liquid transfer pump to maximize the amount of circulating slurry between the upper and lower parts of the absorber.

In the conventional gas layer perforated plate-type flue gas desulfurization apparatus and method (disclosed by Korean Patent No. 130410, U.S. Pat. No. 5,660,616), absorption slurry of upper and lower parts of an absorber positioned on and under a gas dispersing tray is circulated using a difference of hydraulic heads only (a difference of densities) of the absorption slurry between the inside and outside of an overflow weir. On the other hand, in the apparatus of the present invention, since oxidation air is supplied to the absorption slurry riser without any separate circulation pump so that the slurry riser serves as a liquid transfer pump due to the buoyancy of the oxidation air supplied to the slurry riser and the decrease of the density of a gas-liquid (slurry) mixture in the slurry riser, a large amount of the absorption slurry is supplied to the upper portion of the absorber positioned on the gas dispersing tray, thereby drastically increasing the amount of the circulating slurry between on and under the gas dispersion tray.

Although the oxidation air is not supplied into the lower portion of the slurry riser, absorption slurry between on and under the gas dispersing tray is circulated by the difference of hydraulic head (the difference of densities) between the inside and outside of the overflow weir. However, when the oxidation air is supplied into the lower part of the slurry riser, the circulation amount of the absorption slurry between the bubbling layer and reaction layer is drastically increased.

Since limestone slurry serving as an absorbent is supplied directly into the upper part of the gas dispersion tray through the slurry riser, while limestone slurry is injected into the lower part of the absorber in the conventional FGD (Flue Gas Desulfurization) system, it is possible to maximally lower the partial pressure of SO₂ in the absorption slurry in the absorber. Thus, the apparatus of the present invention has a high SO₂ removal rate even at a low operating pH and a low absorber pressure drop (ΔP).

In accordance with the present invention, the above and other objects can be accomplished by the provision of an apparatus for treating flue gas using a single-stage gas dispersing tray, which performs a wet flue gas desulfurization process for removing sulfur dioxide from the flue gas exhausted from a thermal power plant, comprising: the gas dispersing tray installed in an absorber, and comprising a plurality of flue gas inlet pipes for supplying the flue gas to the lower part of the gas dispersing tray, a overflow weir having a designated height formed along the circumference of the gas dispersing tray so that an absorption slurry overflows the overflow weir, and a number of gas holes bored in the gas dispersing tray; an absorption slurry riser connected to the lower surface of the central portion of the gas dispersing tray for supplying absorption slurry from the lower part of the absorber positioned under the gas dispersing tray to the upper part of the gas dispersing tray; a limestone slurry supply pipe connected to the central portion of the slurry ascending riser for supplying limestone slurry serving as an absorbent to a bubbling layer formed on the gas dispersing tray; and an oxidation air injection pipe connected to the lower part of the absorption slurry riser for injecting oxidation air to generate air bubbles.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic sectional view of an apparatus for treating flue gas using a single-stage gas dispersing tray in accordance with the present invention, in a stopped state;

FIG. 2 is a cross-sectional view taken along the line A-A′ of FIG. 1, illustrating one embodiment of the gas dispersing tray;

FIG. 3 is a schematic sectional view of the apparatus of the present invention, in an operating state;

FIG. 4 is a cross-sectional view taken along the line A-A′ of FIG. 1, illustrating another embodiment of the gas dispersing tray; and

FIG. 5 is a cross-sectional view taken along the line A-A′ of FIG. 1, illustrating yet another embodiment of the gas dispersing tray.

### DESCRIPTION OF THE PREFERRED EMBODIMENTS

Now, a preferred embodiment of the present invention will be described in detail with reference to the annexed drawings.

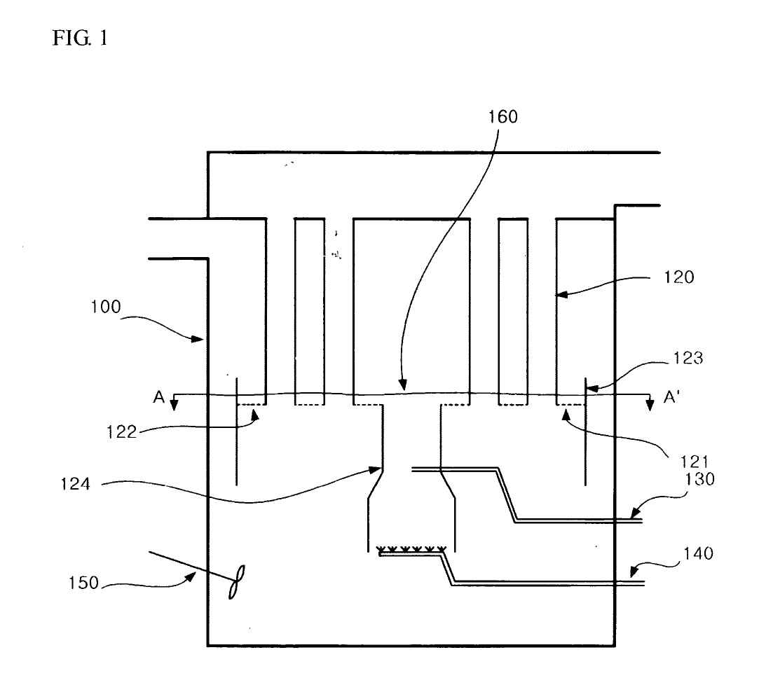

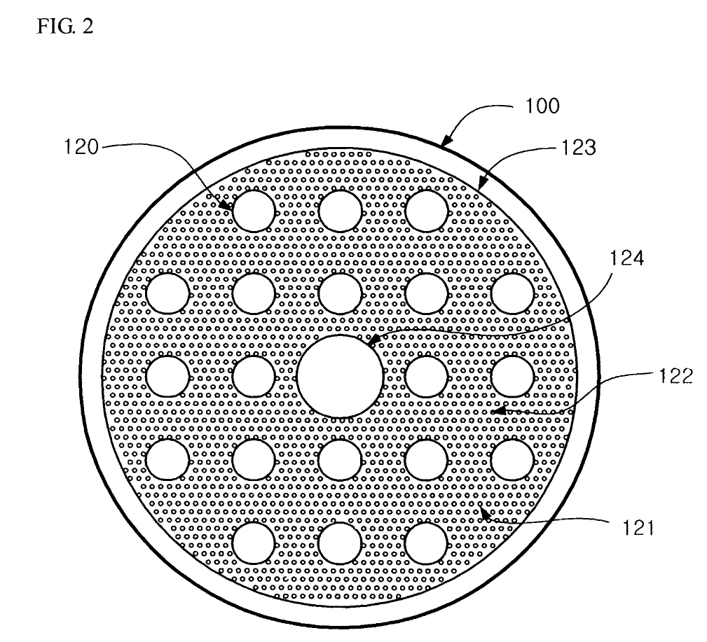

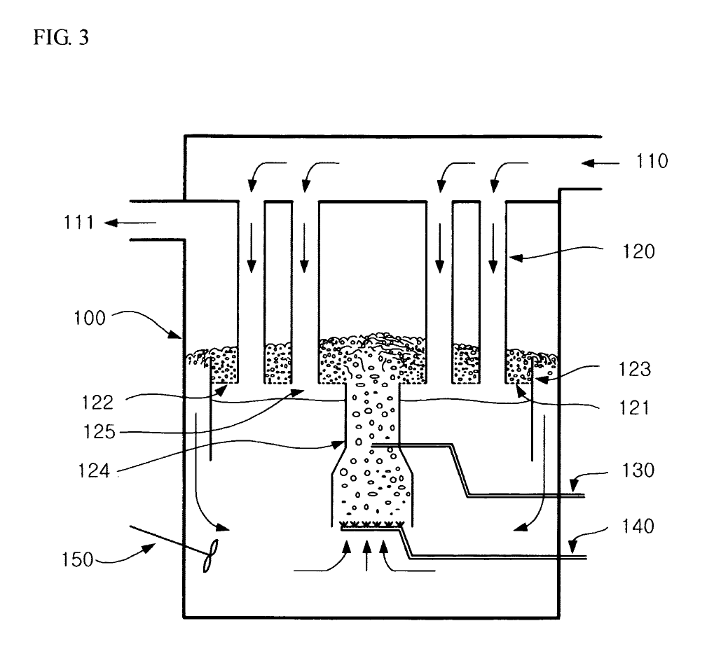

FIG. 1 is a schematic sectional view of an apparatus for treating flue gas using a single-stage gas dispersing tray in accordance with the present invention, in a stopped state, FIG. 2 is a cross-sectional view taken along the line A-A′ of FIG. 1, illustrating one embodiment of the gas dispersing tray, and FIG. 3 is a schematic sectional view of the apparatus of the present invention, in an operating state.

FIG. 1 illustrates an absorber 100 in a state before flue gas is introduced into the absorber 100. Here, an absorption solution fills the inside of the absorber 100 to a designated height above the gas dispersing tray 121.

The absorber 100 of the present invention comprises the gas dispersing tray 121 through which a number of gas holes 122 bored therein, a plurality of flue gas inlet pipes 120 through which the flue gas flows under the gas dispersing tray 121, and an overflow weir 123 having an appropriate height which erects along the circumference of the gas dispersing tray 121 so that the absorption slurry overflows the overflow weir 123.

An absorption slurry riser 124 for supplying absorption slurry from the lower part of the absorber 100 positioned under the gas dispersing tray 121 to the upper part of the absorber 100 positioned on the gas dispersing tray 121 is connected to the central part of the gas dispersion tray 121.

An oxidation air injection pipe 140 is installed at the lower part of the absorption slurry riser 124, and a limestone slurry supply pipe 130 for supplying limestone slurry serving as an absorbent is installed at the central part of the absorption slurry riser 124.

A plurality of V-notches (not shown), which are separated from each other by a designated interval, are formed in the upper end of the overflow weir 123 so that the absorption slurry can smoothly overflow the overflow weir 123 even when the height of a bubbling layer is changed.

The overflow weir 123 is extended downwardly towards the lower part of the absorber 100 positioned under the gas dispersion tray 121. The longer the length of the extended lower end of the overflow weir 123 is, the more smoothly the absorption slurry is circulated. However, in the present invention, the length of the extended lower end of the overflow weir 123 is not limited.

Hereinafter, with reference to FIG. 3, the function and effects of the apparatus for treating flue gas of the present invention will be described in detail.

When oxidation air is supplied from the oxidation air injection pipe 140, installed at the lower part of the absorption slurry riser 124, to the absorber 100 in the stopped state in which the absorption slurry fills the inside of the absorber 100 to a designated level above the gas dispersing tray 121 as shown in FIG. 1, air bubbles are generated in the absorption slurry riser 124, and the generated air bubbles rise due to their buoyancy and forms a gas-liquid (slurry) mixture.

The gas-liquid (slurry) mixture rises at a high speed due to the reduced density, thereby supplying absorption slurry from the lower part of the absorption tower 100 positioned under the gas dispersion tray 121 to the upper part of the absorber 100 positioned on the gas dispersion tray 121. At this time, when the flue gas 110 containing sulfur dioxide is introduced into the absorber 110 through the flue gas inlet pipes 120, a gas layer 125 is formed under the gas dispersing tray 121, and the flue gas is ejected from the gas layer 125 at a high speed through the gas holes 122 bored in the gas dispersing tray 121.

When a bubbling layer is formed on the gas dispersing tray 121 due to the dispersion of the flue gas, sulfur dioxide contained in the flue gas are absorbed into the absorption slurry, react with oxygen of the oxidation air to produce sulfuric acid, and simultaneously react with the limestone slurry supplied into the absorption slurry riser 124 to produce gypsum crystal.

The low density of the gas-liquid (slurry) mixture in the absorption slurry riser 124 and the difference of hydraulic heads (the difference of densities) of the absorption slurry between the inside and the outside of the overflow weir 123 serve as a driving force for circulating the absorption slurry positioned on and under the gas dispersing tray 121. Thereby, the absorption slurry of the bubbling layer flows towards the overflow weir 123 installed at the edge of the gas dispersing tray 121, overflows the overflow weir 123, and descends towards the lower portion of the absorber 100, and the absorption slurry as much as the amount of the descending absorption slurry rises towards the upper part of the gas dispersing tray 121 through the absorption slurry riser 124, thus being capable of continuously removing SO₂.

Important factors of the apparatus of the present invention include the diameter of the gas holes 122, and the opening ratio of the gas holes 122, the diameter of the flue gas inlet pipes 120, the ratio of a sum of sectional area occupied by the flue gas inlet pipes 120 to the area of the gas dispersing tray 121, and the flow rate of the flue gas in the flue gas inlet pipes 120 and the gas holes 122. In order to maximally increase the gas-liquid contact area of the bubbling layer on the gas dispersing tray 121, the apparatus of the present invention preferably satisfies the following

| | |
|---|---|
| Diameter of Gas Holes: | 5˜20□ |
| Opening Ratio of Gas Spray Holes: | 0.2˜0.8 |
| Diameter of Flue Gas Inlet Pipes: | 200˜500□ |
| Flow Rate of Flue Gas in Flue Gas Inlet Pipes: | 10˜25 m/s |
| Ratio of a sum of sectional area occupied by Flue Gas | 0.1˜0.2 |
| Inlet Pipes to the area of Gas Dispersion Tray: | |

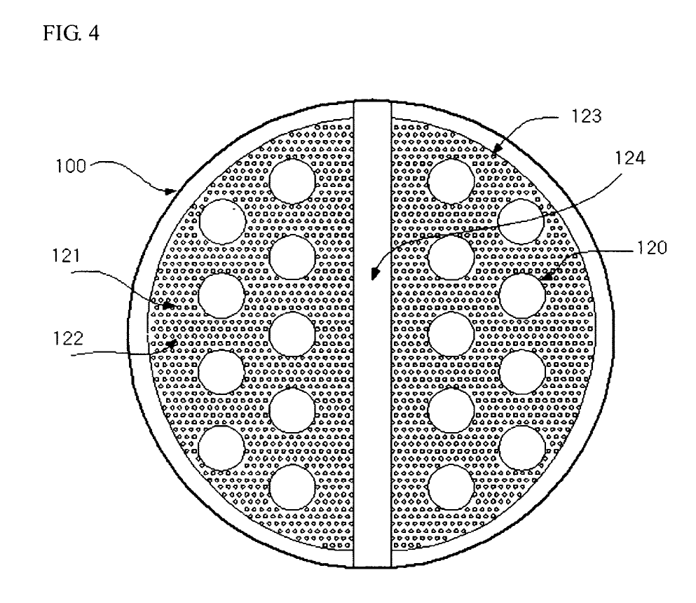

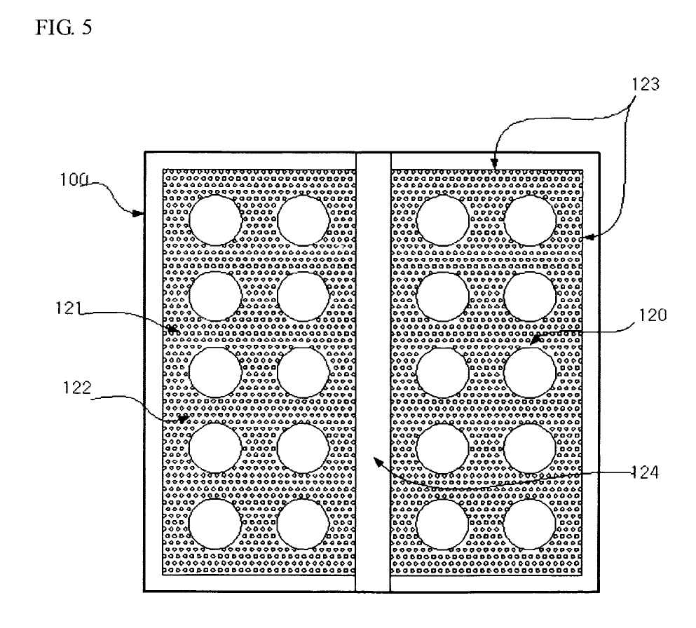

FIGS. 4 and 5 are cross-sectional views illustrating other embodiments of the gas dispersing tray 121. Another embodiment of the gas dispersing tray 121 as shown in FIG. 4 comprises the absorption slurry riser 124 having a rectangular cross section crossing the center of the absorption tower so that the gas dispersing tray 121 is easily applied to a large-capacity apparatus. Yet another embodiment of the gas dispersing tray 121 as shown in FIG. 5, has a rectangular shape and comprises the absorption slurry riser 124 having a rectangular cross section crossing the center of the absorption tower similarly to the embodiment of the gas dispersing tray 121 as shown in FIG. 4 so that the gas dispersing tray 121 is installed in an absorber having a rectangular cross section.

As apparent from the above description, the present invention provides an apparatus for treating flue gas using a single-stage gas dispersing tray, in which the circulation of absorption slurry positioned in upper and lower portions of an absorber on and under the gas dispersing tray depends not only on a difference of hydraulic heads (a difference of densities) of the absorption slurry between the inside and outside of an overflow weir but also on the supply of oxidation air through an absorption slurry riser so that the absorption slurry riser causes the decrease of the density of a gas-liquid (slurry) mixture and serves as a liquid transfer pump, differing from the conventional gas layer perforated plate-type flue gas desulfurization apparatus and method (disclosed by Korean Patent No. 130410), thereby drastically increasing the circulation amount of the absorption slurry positioned in the upper and lower parts of an absorption tower on and under the gas dispersing tray.

Since the limestone slurry serving as an absorbent is supplied into the absorption slurry riser and is then supplied directly to a bubbling layer formed on the gas dispersing tray so that the partial pressure of SO₂ in the absorption slurry in the bubbling layer formed on the gas dispersing tray is maintained to approximately zero, the apparatus of the present invention has a high SO₂ removal efficiency even at a low operating pH and a low absorber pressure drop (ΔP). Further, the apparatus of the present invention drastically increases the limestone utilization, compared to the conventional absorber.

The apparatus of the present invention is easily scaled up and down because the amount of flue gas to be treated per flue gas inlet pipe is fixed.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for treating flue gas using a single-stage gas dispersing tray, which performs a wet flue gas desulfurization process for removing sulfur dioxide from the flue gas exhausted from a thermal power plant, comprising:
the gas dispersing tray installed in an absorber, and comprising a plurality of flue gas inlet pipes for supplying the flue gas to the lower part of the absorber positioned under the gas dispersing tray, an overflow weir having a designated height formed along the circumference of the gas dispersing tray so that an absorption slurry overflows the overflow weir, and a number of gas holes bored in the gas dispersing tray;
an absorption slurry riser connected to the lower surface of the central part of the gas dispersing tray for supplying absorption slurry from the lower part of the absorber positioned under the gas dispersing tray to the upper part of the absorber positioned on the gas dispersing tray;
a limestone slurry supply pipe connected to the central portion of the absorption slurry riser for supplying limestone slurry serving as an absorbent to a bubbling layer formed on the gas dispersing tray; and
an oxidation air injection pipe connected to the lower part of the absorption slurry riser for injecting oxidation air to generate air bubbles.

2. The apparatus as set forth in claim 1, wherein the overflow weir is extended downwardly towards the lower part of the absorber positioned under the gas dispersing tray.

3. The apparatus as set forth in claim 1, wherein the diameter of the gas holes is 5˜20□, the opening ratio of the gas holes is 0.2˜0.8, the diameter of the flue gas inlet pipes is 200˜500□, the flow rate of the flue gas in the flue gas inlet pipes is 10˜25 m/s, and the ratio of a sum of the area occupied by the flue gas inlet pipes to the area of gas dispersing tray is 0.1˜0.2.

4. The apparatus as set forth in claim 1, wherein a plurality of V-notches, which are separated from each other by a designated interval, are formed in the upper end of the overflow weir so that the absorption slurry can smoothly overflow the overflow weir even when the height of the bubbling layer is changed.

5. The apparatus as set forth in claim 1, wherein:
the gas dispersing tray has a circular or rectangular shape; and
the absorption slurry riser has a circular cross section connected to the central part of the gas dispersing tray, or a rectangular cross section crossing the center of the absorber.
